(19) United States
(12) Patent Application Publication
(10) Pub. No.: US 2021/0220750 A1
(43) Pub. Date: Jul. 22, 2021

(54) ACTION ROBOT

(71) Applicant: LG ELECTRONICS INC., Seoul (KR)

(72) Inventors: Wonhee LEE, Seoul (KR); Sanghun KIM, Seoul (KR); Seungmin BAEK, Seoul (KR)

(21) Appl. No.: 16/649,460

(22) PCT Filed: Mar. 6, 2019
(86) PCT No.: PCT/KR2019/002585

§ 371 Date: Mar. 20, 2020

(51) Int. Cl. A63H 3/46; A63H 13/00

(52) U.S. Cl. CPC A63H 3/46; A63H 13/00

(57) ABSTRACT

The present invention relates an action robot including at least one joint. The action robot may include: a joint configured to allow a movable part to be rotatably connected to a main body; a joint elastic member configured to provide elastic force in a direction in which the joint is unfolded; a wire connected to the movable part to pull the movable part in a direction in which the joint is folded; a rotation link which is disposed within the main body and to which the wire is connected, the rotation link rotating about a rotation shaft; an elevation rod configured to press the rotation link upward so that the rotation link rotates; and a driving source configured to allow the elevation rod to move upward. The main body may include: a first body in which the rotation link is built; and a second body which is separably coupled to the first body and in which at least a portion of the elevation rod is built.

### TECHNICAL FIELD

The present invention relates to an action robot, and more particularly, to an action robot including at least one joint.

### BACKGROUND ART

As robot technologies are developed, a method of constructing a robot by modularizing joints or wheels is being used. For example, a plurality of actuator modules constituting the robot are electrically and mechanically connected and assembled to provide various types of robots such as dogs, dinosaurs, humans, and spiders.

Such a robot that is capable of being manufactured by assembling the plurality of actuator modules is commonly called a modular robot. Each of the actuator modules constituting the modular robot is provided with a motor therein to execute a motion of the robot according to rotation of the motor. The motion of the robot is a concept that collectively refers to movement of the robot such as a motion and a dance.

Recently, as robots for entertainment become distinguished, interest in robots for encouraging entertainment or human interest is increasing. For example, techniques that allow the robots to dance to music or to take motions or facial expressions in line with stories (such as fairy tales).

Here, a plurality of motions that are suitable for music or fairy tales are previously set, and when the music or fairy tales are played from an external device, the action robots perform corresponding motions by executing the preset motions.

### DISCLOSURE OF THE INVENTION

### Technical Problem

An object of the present invention is to provide an action robot that is simply assembled and easily maintained and repaired.

Another object of the present invention is to provide a fast and responsive action robot.

### Technical Solution

An action robot according to an embodiment of the present invention includes: a joint configured to allow a movable part to be rotatably connected to a main body; a joint elastic member configured to provide elastic force in a direction in which the joint is unfolded; a wire connected to the movable part to pull the movable part in a direction in which the joint is folded; a rotation link which is disposed within the main body and to which the wire is connected, the rotation link rotating about a rotation shaft; an elevation rod configured to press the rotation link upward so that the rotation link rotates; and a driving source configured to allow the elevation rod to move upward. The main body may include: a first body in which the rotation link is built; and a second body which is separably coupled to the first body and in which at least a portion of the elevation rod is built.

The elevation rod may ascend between the movable part and the rotation shaft and press the rotation link.

The rotation link may include: a rotation shaft connection part to which the rotation shaft is connected; a first extension part extending from the rotation shaft connection part to the movable part, the first extension part being pressed by the elevation rod; and a second extension part extending from the rotation shaft connection part in a direction in which the second extension part is angled at a predetermined angle with respect to the first extension part.

The action robot may further include a guide part disposed within the main body and configured to guide the elevation of the elevation rod.

A hook part protruding or unfolded in a radial outward direction of the elevation rod may be disposed on the elevation rod, and a limiter on which the hook part is hooked to restrict an elevation range of the elevation rod may be disposed on the guide part.

The driving source may be disposed below the second body.

The action robot may further include: a sub base coupled to the second body; and a base module in which the driving source is built, the base module being disposed below the sub base to support the sub base.

A first magnet may be disposed on one of the sub base and the base module, and a second magnet or magnetic body which is attracted to the first magnet may be disposed on the other of the sub base and the base module.

The wire may have one end connected to the rotation link and the other end connected to the movable part, and a wire through-hole through which the wire passes may be defined in the first body.

The wire may be lengthily disposed in a direction in which the wire decreases in height from the one end to the other end.

### Advantageous Effects

According to the preferred embodiment of the present invention, the first body and the second body may be separably coupled to each other. Thus, not only the assembly of the main body may be simplified, but also the maintenance of the various components disposed inside the main body may be facilitated.

Also, the rotation link may be built in the first body, and at least a portion of the elevation rod may be built in the second body. Thus, there may be the advantage that the rotation link and the elevation rod are directly interlocked with each other when the first body and the second body are assembled.

Also, the robot module and the base module may be coupled by the attraction force between the first magnet and the second magnet (or between magnetic materials). Thus, the user may easily couple or separate the robot module to/from the base module. Also, the various base modules and various robot modules may be combined to provide the personalized action robot.

Also, the wire pulling the movable part may be connected to the rotation link, and the rotation link may rotate by the elevation rod. Thus, since the length of the wire is relatively short, it may be easy to adjust the appropriate length of the wire when the action robot is manufactured.

Also, since the length of the wire is relatively short, the wire may be easily maintained in the tight state. Therefore, the responsiveness of the movable part may be quick and immediate.

Also, the wire may be inclined in the direction in which the height is lowered toward the movable part in the rotation link. Thus, it may be possible to prevent the wire from being caught or contacting the inside of the main body and thus to generate the friction, and the durability of the wire may be improved.

Also, since the power of the driving source is transmitted to the wire through the elevation rod and the rotation link, which are rigid bodies, the operation reliability may be improved as compared to the case in which the wire is directly connected to the driving source. Also, the power required for the driving source may be reduced, to miniaturize the driving source and reduce the noise and vibration of the driving source.

### BRIEF DESCRIPTION OF THE DRAWINGS

FIG. 1 is a perspective view of an action robot according to an embodiment of the present invention.

FIG. 2 is a perspective view of a robot module according to an embodiment of the present invention.

FIG. 3 is a view illustrating a configuration of the action robot according to an embodiment of the present invention.

FIG. 4 is a partial enlarged view of a portion “A” of FIG. 3.

FIG. 5 is a view for explaining a folding operation of a joint according to an embodiment of the present invention.

FIG. 6 is a view for explaining an unfolding operation of the joint according to embodiment of the present invention.

FIG. 7 is a view of a wire connector according to an embodiment of the present invention.

FIG. 8 is a view for explaining an operation of the wire connector according to an embodiment of the present invention.

FIG. 9 is a view illustrating a configuration of an action robot according to another embodiment of the present invention.

### MODE FOR CARRYING OUT THE INVENTION

Hereinafter, detailed embodiments of the present invention will be described in detail with reference to the accompanying drawings.

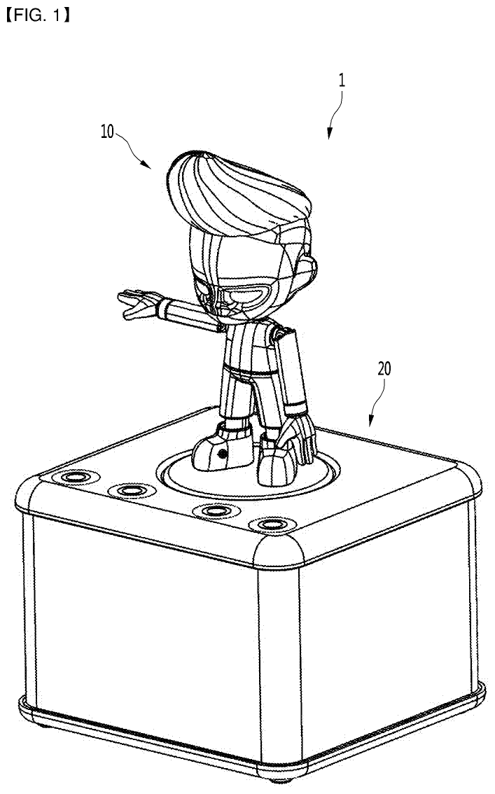

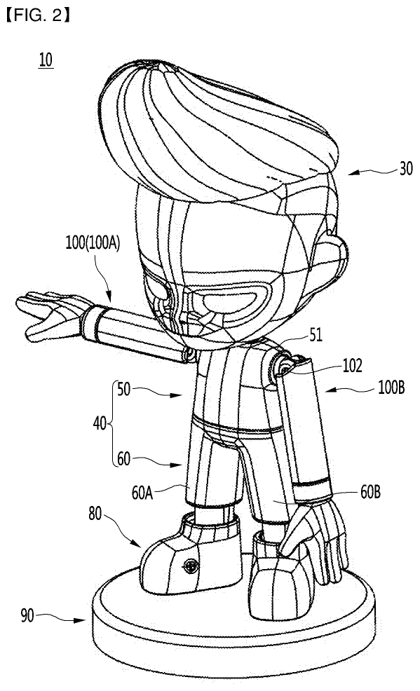

FIG. 1 is a perspective view of an action robot according to an embodiment of the present invention, and FIG. 2 is a perspective view of a robot module according to an embodiment of the present invention.

An action robot 1 according to an embodiment of the present invention may include a robot module 10 and a base module 20 supporting the robot module 10 from a lower side.

The robot module 10 may have a shape that is approximately similar to a human body.

The robot module 10 may include a head 30, a main body 40, and an arm 100. The robot module 10 may further include a foot 80 and a sub base 90.

The head 30 may have a shape corresponding to the head of a person. The head 30 may be connected to an upper portion of the main body 40.

The main body 40 may have a shape corresponding to the body of the person. The main body 40 may be fixed so as not to move. A space in which various components are built may be defined in the main body 400.

The main body 40 may include a first body 50 and a second body 60.

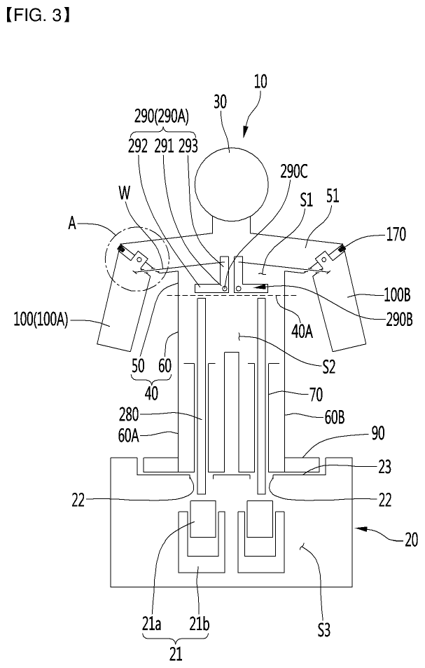

An inner space S1 (see FIG. 3) of the first body 50 and an inner space S2 (see FIG. 3) of the second body 60 may communicate with each other.

The first body 50 may have a shape corresponding to the upper body of the person. The first body 50 may be called an upper body. The arm 100 may be connected to the first body 50.

The second body 60 may have a shape corresponding to the lower body of the person. The second body 60 may be called a lower body. The second body 60 may include a pair of legs 60A and 60B. The pair of legs 60A and 60B may include a right leg 60A and a left leg 60B.

The first body 50 and the second body 60 may be separably coupled to each other. Thus, not only assembly of the main body 40 may be simplified, but also the components disposed inside the main body 40 may be easily maintained and repaired.

The arm 100 may be connected to each of both sides of the main body 40.

In more detail, the pair of arms 100 may be connected to shoulders 51 disposed at both sides of the first body 50, respectively. The shoulders 51 may be provided in the first body 50. Each of the shoulders 51 may be disposed at each of both upper portions of the first body 50.

The arm 100 may be rotatable with respect to the body 40, more particularly, the shoulder 51. Thus, the arm 100 may be called a movable part.

The pair of arms 100 may include a right arm 100A and a left arm 100B. The right arm 100A and the left arm 100B may move independently with respect to each other.

The foot 80 may be connected to a lower portion of the second body 60, i.e., a lower end of each of the legs 60A and 60B. The foot 80 may be supported by the sub base 90.

The sub base 90 may be coupled to at least one of the second body 60 or the foot 80. The sub base 90 may be seated and coupled to the base module 20 from an upper side of the base module 20.

The sub base 90 may have a substantially circular plate shape. The sub base 90 may rotate with respect to the base module 20. Thus, the entire robot module 10 may rotate with respect to the sub base 90.

The base module 20 may support the robot module 10 at the lower side. In more detail, the base module 20 may support the sub base 90 of the robot module 10 at the lower side. The sub base 90 may be separably coupled to the base module 20.

A controller (not shown) controlling an overall operation of the action robot 1, a battery (not shown) storing power required for the operation of the action robot 1, and a driving source 21 (see FIG. 3) that drives the robot module 10 may be built in the base module 20. Also, a speaker that emits sound may be disposed in the base module 20.

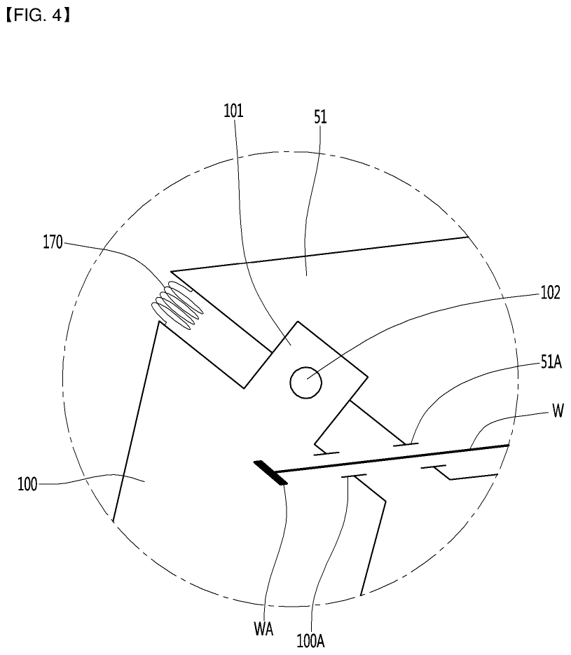

FIG. 3 is a view illustrating a configuration of the action robot according to an embodiment of the present invention, and FIG. 4 is a partial enlarged view of a portion “A” of FIG. 3.

A seating part 23 on which the sub base 90 is seated may be defined in a top surface of the base module 20. The seating part 23 may be recessed to be stepped downward from the top surface of the base module 20.

Spaces S1 and S2 may be defined in the main body 40. The space S1 and S2 may include an inner space S1 of the first body 50 and an inner space S2 of the second body 60.

The first body 50 and the second body 60 may be separably coupled to each other. That is, a boundary between the first body 50 and the second body 60 may be provided on the main body 40, and the first body 50 and the second body 60 may be separated from or coupled to each other along the boundary 40A.

The action robot 1 according to an embodiment of the present invention includes a joint 102 rotatably connecting the arm 100 with respect to the main body 40 and a joint elastic member 170 that provides elastic force in a direction in which the joint 102 is unfolded.

The joint 102 may rotatably connect the shoulder 51 to the arm 100. The joint 102 may define a rotation axis of the arm 100.

A joint connection part 101 to which the joint 102 is connected may be disposed on the arm 100. The joint connection part 101 may protrude from an upper end of the arm 100 toward the shoulder 51.

The joint elastic member 170 may connect the arm 100 to the shoulder 51. The joint elastic member 170 may include a spring. The joint elastic member 170 may provide elastic force to the arm 100 in the direction in which the joint 102 is unfolded.

When the joint 102 is folded, outer portions of the arm 100 and the shoulder 51 may be spread relative to each other, and inner portions of the arm 100 and the shoulder 51 may be close to each other. That is, when the joint 102 is folded, an armpit may be tightened.

The joint elastic member 170 may connect the outer portions of the arm 100 and the shoulder 51 to each other. That is, the joint elastic member 170 may be disposed on an opposite side of the main body 40 with respect to the joint 102. Thus, when the joint 102 is folded, the joint elastic member 170 may be stretched to provide the elastic force in the direction in which the joint 102 is unfolded.

The joint elastic member 170 connected to the right arm 100A may be connected to an upper right portion of the right arm 100A. The joint elastic member 170 connected to the left arm 1008 may be connected to an upper left portion of the left arm 1008.

The action robot 1 according to an embodiment of the present invention may include a driving source 21, an elevation rod 280, a rotation link 290, and a wire W.

Each of the elevation rod 280 and the rotation link 290 may be a rigid body.

The driving source 21 may push the elevation rod 280 upward. A kind of driving source 21 is not limited. For example, the driving source 21 may include a servo motor. For another example, the driving source 21 may include an actuator.

The driving source 21 may be built in the base module 20. That is, the driving source 21 may be disposed in an inner space S3 of the base module 20.

The driving source 21 may press the elevation rod 280 downward. A position of the driving source 21 and the number of driving sources 21 may correspond to a position of the elevation rod 280 and the number of elevation rods 280. For example, a pair of driving sources 21 and a pair of elevation rods 280 may be provided.

The driving source 21 may include a fixed part 21a and a movable part 21b.

The fixed part 21a may be fixed inside the base module 20. The movable part 21b may move relative to the fixed part 21a. For example, the movable part 21b may move vertically with respect to the fixed part 21a. The movable part 21b may contact a lower end of the elevation rod 280 to press the elevation rod 280 upward.

At least a portion of the elevation rod 280 may be built in the main body 40. In more detail, at least a portion of the elevation rod 280 may be built in the second body 60.

For example, the elevation rod 280 may extend from the inside of the second body 60 to the inside of the base module 20. In this case, the elevation rod 280 may pass through the inside of the foot 80 (see FIG. 2) and the sub base 90.

Also, a rod through-hole 22 through which the elevation rod 280 passes may be defined in a top surface of the base module 20. In more detail, the rod through- hole 22 may be defined so that the seating part 23 passes through the rod through-hole 22 vertically.

The elevation rod 280 may be lengthily disposed vertically.

The elevation rod 280 may be elevated by the driving source 21. The elevation rod 280 may press the rotation rod 290 upward to allow the rotation link 290 to rotate. In more detail, a lower end of the elevation rod 280 may be pressed upward by the driving source 21, and an upper end of the elevation rod 280 may push the rotation link 290 upward to allow the rotation link 290 to rotate.

The elevation rod 280 may be provided in plurality. Each of the plurality of elevation rods 280 may allow one rotation link 290 to rotate. That is, the number of elevation rods 280 may correspond to that of rotation links 290.

The elevation operation of each of the elevation rods 280 may be guided by a guide part 70 disposed inside each of the legs 60A and 60B. That is, the guide part 70 may be provided inside each of the legs 60A and 60B to guide the elevation operation of the elevation rod. The guide part 70 may be provided as a separate member with respect to the second body 60 and then be built in each of the legs 60A and 60B or be integrated with each of the legs 60A and 60B.

A plurality of guide parts 70 may be provided. The number of guide parts 70 may correspond to that of elevation rods 280. For example, as illustrated in FIG. 3, one elevation rod 280 may be disposed on each of the right leg 60A and the left leg 60B. In this case, the guide parts 70 may be disposed on the right leg 60A and the left leg 60B, respectively.

The rotation link 290 may be built in the first body 50. That is, the rotation link 290 may be disposed in the inner space S1 of the first body 50. The rotation link 290 may be disposed above the elevation rod 280.

The rotation link 290 may rotate about a rotation shaft 290c. The rotation shaft 290c may be fixed within the first body 50. The rotation link 290 may rotate by the elevation rod 280 to pull the wire W.

The rotation link 290 may be provided in plurality. The number of rotation links 290 may correspond to the number of joints 102. For example, the plurality of rotation links 290 may include a first rotation link 290A connected to the right arm 100A through the wire W and a second rotation link 290B connected to the left arm 100B through the wire W. The first rotation link 290A and the second rotation link 290B may be bilaterally symmetric with each other.

The first rotation link 290A may have a shape in which the “ [symbol] ” shape is bilaterally symmetrical, and the second rotation link 290B may have a “ [symbol] ” shape.

The rotation link 290 includes a rotation shaft connection part 291 to which the rotation shaft 290c is connected, a first extension part 292 pressed by the elevation rod 280, and a second extension part 293 to which the wire W is connected.

The rotation link 290 may be integrally provided. Each of the first extension part 292 and the second extension part 293 may have a rectangular bar shape, but are not limited thereto.

The first extension part 292 may extend horizontally from the rotation shaft connection part 291.

The first extension part 292 may extend from the rotation shaft connection part 291 toward the arm 100. Thus, the first extension part 292 of the first rotation link may extend to a right side from the rotation shaft connection part 291, and the first extension part 292 of the second rotation link may extend to a left side from the rotation shaft connection part 291.

The second extension part 293 may extend from the rotation shaft connection part 291 in a direction in which a predetermined angle is defined with respect to the first extension part 292. Preferably, the second extension part 293 may be perpendicular to the first extension part 292. The second extension part 293 may extend upward from the rotation shaft connection part 291.

The wire W may be connected to the second extension part 293. In more detail, the wire W may be connected to an upper end of the second extension 293. The connection method between the wire W and the second extension part 293 will be described in detail later.

The elevation rod 280 may ascend between the arm 100 and the rotation shaft 290c to press the rotation link. In more detail, the elevation rod 280 may ascend between the arm 100 and the rotation shaft 290c to press the first extension part 292. In this case, the rotation link 290 may rotate about the rotation shaft 290c to pull the wire W connected to the second extension part 293.

The first rotation link 290A and the second rotation link 290B may rotate in opposite directions. In more detail, the first rotation link 290A may be pressed upward by the elevation rod 280 to rotate in a clockwise direction and pull the wire W connected to the right arm 100A. The second rotation link 290B may be pressed upward by the elevation rod 280 to rotate in a counterclockwise direction and pull the wire W connected to the left arm 1008.

The wire W may connect the arm 100 to the rotation link 290. In more detail, the wire W may have one end connected to the second extension 293 of the rotation link 290 and the other end connected to the arm 100.

The wire W may be provided in plurality. The number of wires W may correspond to that of joints 102.

The wire W may be tightly maintained by tension. A material of the wire W may vary as necessary. However, to minimize breakage of the wire W and improve reliability of a product, the wire W preferably includes a material having high strength. For example, the wire W may include a metal material.

For another example, the wire W may include a material that is the same as or similar to a fishing line. In more detail, the wire W may include at least one material of nylon, carbon fiber, or polyethylene.

The main body 40 may have a wire through-hole 51A through which the wire W passes. In more detail, the wire through-hole 51A may be defined in the shoulder 51.

The arm 100 may have a wire hooking hole 100A on which the wire W is hooked. In more detail, the wire hooking hole 100A may be defined in an upper end of the arm 100.

The wire through-hole 51A may be defined in an inner portion of the shoulder 51. Also, the wire locking hole 100A may be defined in an inner portion of the arm 100.

In more detail, the wire through-hole 51A and the wire hooking hole 100A may be defined at a side that is opposite to the joint elastic member 170 with respect to the joint 102. That is, the wire through-hole 51A and the wire hooking hole 100A may be defined in a portion corresponding to the armpit. Thus, when the wire W is pulled, the arm 100 may operate in a direction in which the joint 102 is folded.

A hook part WA may be disposed on an end of the wire W. For example, the hook part WA may be provided by heating and dissolving the end of the wire W so as to be hardened. For another example, the hook part WA may be a knot disposed on the wire W.

The hook part WA may have a thickness greater than that of the wire W. Thus, the wire W may pass through the wire hooking hole 100A. On the other hand, the hook part WA may not pass through the wire hooking hole 100A and thus be hooked around the wire hooking hole 100A.

One end of both ends of the wire W, which is connected to the rotation link 290, may be disposed at a point higher than the other end connected to the arm 100. The wire W may be inclined in a direction in which the height decreases from the one end to the other end. That is, the wire W may be inclined in a direction in which the height decreases from the rotation link 290 toward the arm 100.

Thus, it is possible to prevent the wire W from contacting the portion at which the shoulder 51 and the first body 50 are connected to each other, thereby generating the friction.

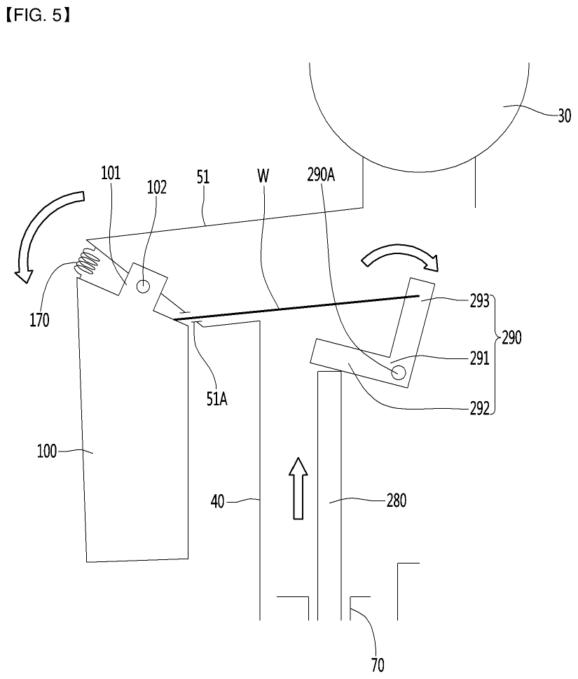

FIG. 5 is a view for explaining a folding operation of the joint according to an embodiment of the present invention.

When the driving source 21 (see FIG. 3) may press the lower end of the elevation rod 280 upward, the elevation rod 280 may ascend. In this case, the upper end of the elevation rod 280 may press the first extension part 292 of the rotation link 290 upwards, and the rotation link 290 may rotate in one direction (for example, in the clockwise direction) about the rotation shaft 290c.

When the rotation link 290 rotates, the wire W connected to the second extension 293 may pull the arm 100 in the direction in which the joint 102 is folded. Thus, the arm 100 may rotate with respect to the main body 100 by the tension of the wire W. For example, the arm 100 may rotate in a direction close to the main body 100. Here, the joint elastic member 170 may be tensioned.

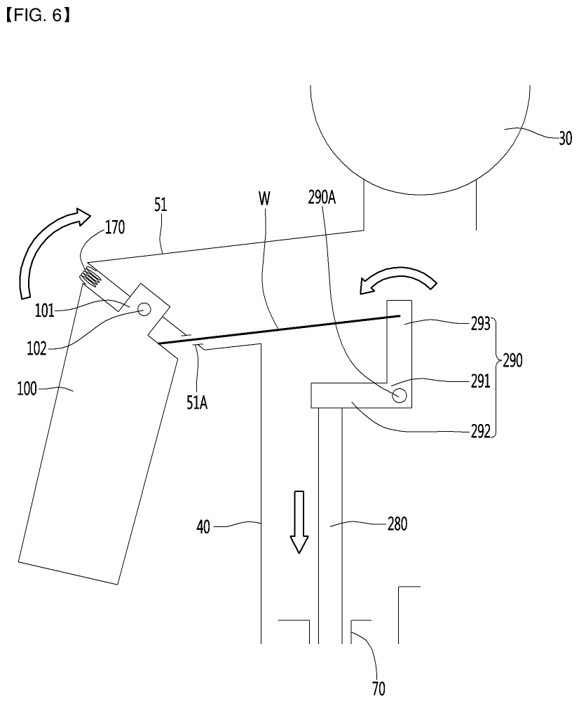

FIG. 6 is a view for explaining an unfolding operation of the joint according to embodiment of the present invention.

The joint elastic member 170 may provide elastic force to the arm 100 in the direction in which the joint 102 is unfolded. Thus, if the driving source 21 (see FIG. 3) does not press the lower end of the elevation rod 280 upward, the arm 100 may rotate in the other direction, for example, the direction away from the main body 100, with respect to the main body 40 by the elastic force 170 of the joint elastic member 170.

When the arm 100 rotates, the wire W connected to the arm 100 may pull the second extension part 293 of the rotation link 290. Thus, the rotation link 290 may rotate in the other direction (for example, in the counterclockwise direction) about the rotation shaft 290c.

Also, the elevation rod 280 may descend by gravity. Alternatively, the rotation link 290 may rotate to allow the first extension part 292 to press the elevation rod 280 downward.

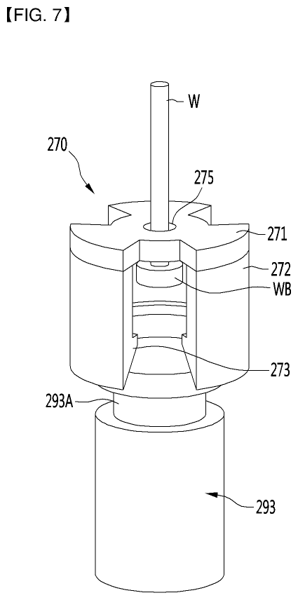

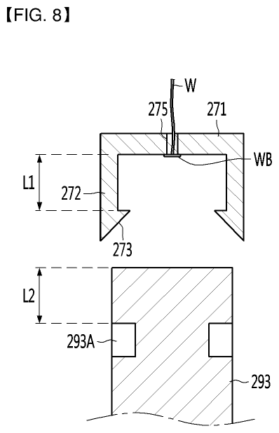

FIG. 7 is a view of a wire connector according to an embodiment of the present invention, and FIG. 8 is a view for explaining an operation of the wire connector according to an embodiment of the present invention.

The action robot 1 according to this embodiment may further include a wire connector 270. The wire connector 270 may connect the wire W to the second extension part 293 of the rotation link 290.

In more detail, the wire connector 270 may include a first part 271 disposed above the second extension part 293 and a second part 272 extending downward from the first part 271.

The first part 271 may have a substantially horizontal plate shape. A bottom surface of the first part 271 may face an upper end of the second extension 293.

A through-hole 275 through which the wire W passes may be defined in the first part 271. The through-hole 275 may be defined to pass through the first part 271 vertically.

A hook part WB may be disposed on an end of the wire W. For example, the hook part WB may be provided by heating and dissolving the end of the wire W so as to be hardened. For another example, the hook part WB may be a knot disposed on the wire W.

The hook part WB may be disposed below the first part 271. The hook part WB may be disposed between the first part 271 and the upper end of the elevation rod 280.

The hook part WB may have a thickness greater than that of the wire W. Thus, the hook part WB may not pass through the through-hole 275 and may be hooked around the through-hole 275.

The second part 272 may extend downward from an edge of the first part 271. An inner surface of the second part 272 may face an outer circumference of the second extension 293. The second part 272 may be provided in plurality that are spaced apart from each other.

A hook 273 may be disposed on the second part 272. In more detail, the hook 273 may protrude from the inner surface of the second part 272 toward the second extension part 293. In this case, a locking groove 282 to which the hook 273 is hooked may be defined in the outer circumference of the second extension part 293.

The second part 272 may be elastically deformed within a predetermined range. Thus, when the hook 273 contacts the outer circumference of the second extension 293, the second part 272 may be spread relative to each other. In this state, when the wire connector 270 descends, the hook 273 may be hooked with the hooking groove 282 by the elastic force itself of the second part 272. Thus, the wire connector 270 may be firmly fixed to the second extension part 293.

The hooking groove 282 may be lengthily defined in the circumferential direction of the second extension part 293.

A vertical distance L1 from the bottom surface of the first part 271 to the upper end of the hook 273 may be equal to or greater than a vertical distance L2 from the upper end of the second extension 293 to the locking groove 282. Preferably, the vertical distance L1 from the bottom surface of the first part 271 to the upper end of the hook 273 may be the same as the sum of the vertical distance L2 from the upper end of the second extension 293 to the locking groove 282 and the vertical thickness of the hook part WB.

Thus, when the hook 273 is hooked with the locking groove 282, the hook part WB disposed on the end of the wire W may be pressed and fixed between the first part 271 and the upper end of the second extension part 293. As a result, when the rotation link 290 rotates, the wire W may be immediately tensioned, and reactivity of the arm 100 connected to the wire W may be improved.

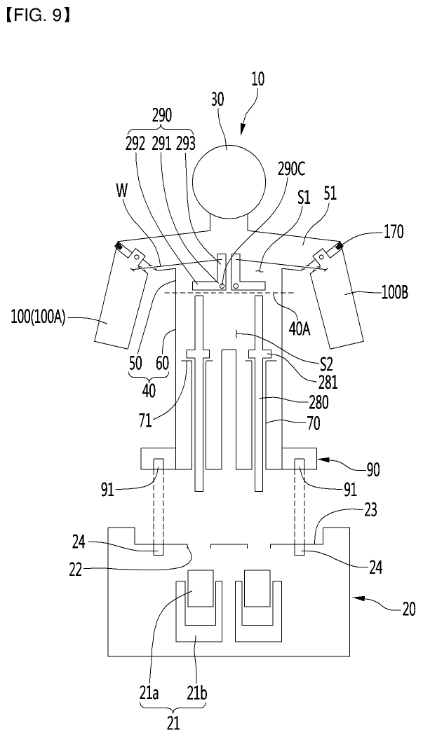

FIG. 9 is a view illustrating a configuration of an action robot according to another embodiment of the present invention.

Hereinafter, contents duplicated with the foregoing embodiment will be omitted, and differences will be mainly described.

A hook part 281 may be disposed on an elevation rod 280 according to this embodiment, and a limiter 71 on which the hook part 281 is hooked may be disposed on a guide part 70.

The hook part 281 may protrude or extend in a radially outward direction of the elevation rod 280.

The limiter 71 may be disposed below the hook part 281. The limiter 71 may limit an elevation range of the elevation rod 280. In more detail, the limiter 71 may prevent the hook part 281 from being separated downward.

On the other hand, one of a sub base 90 and a base module 20 may be provided with a first magnet, the other of the sub base 90 and the base module 20 may be provided with a second magnet or a magnetic body on which attractive force with respect to the second magnet acts.

Hereinafter, a case in which the first magnet 91 is provided on the sub base 90, and the second magnet 24 is provided on the base module 20 will be described as an example.

The first magnet 91 and the second magnet 24 may act as mutual attraction. The first magnet 91 and the second magnet 24 may vertically overlap each other.

The first magnet 91 may be disposed on a bottom surface of the sub base 90. The bottom surface of the first magnet 91 may be continuously connected to the bottom surface of the sub base 90 without being stepped.

The second magnet 24 may be disposed on a top surface of a seating part 23 of the base module 20. The top surface of the second magnet 24 may be continuously connected to the top surface of the seating portion 23 without being stepped.

The base module 20 and the sub base 90 may be easily coupled to each other by the first magnet 71 and the second magnet 24.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present disclosure.

1. An action robot comprising:
a joint configured to allow a movable part to be rotatably connected to a main body;
a joint elastic member configured to provide elastic force in a direction in which the joint is unfolded;
a wire connected to the movable part to pull the movable part in a direction in which the joint is folded;
a rotation link which is disposed within the main body and to which the wire is connected, the rotation link rotating about a rotation shaft;
an elevation rod configured to press the rotation link upward so that the rotation link rotates; and
a driving source configured to allow the elevation rod to move upward, wherein the main body comprises:
a first body in which the rotation link is built; and
a second body which is separably coupled to the first body and in which at least a portion of the elevation rod is built.

2. The action robot according to claim 1, wherein the elevation rod ascends between the movable part and the rotation shaft and presses the rotation link.

3. The action robot according to claim 1, wherein the rotation link comprises:
a rotation shaft connection part to which the rotation shaft is connected;
a first extension part extending from the rotation shaft connection part to the movable part, the first extension part being pressed by the elevation rod; and
a second extension part extending from the rotation shaft connection part in a direction in which the second extension part is angled at a predetermined angle with respect to the first extension part.

4. The action robot according to claim 1, further comprising a guide part disposed within the main body and configured to guide the elevation of the elevation rod.

5. The action robot according to claim 4, wherein a hook part protruding or expanded in a radial outward direction of the elevation rod is disposed on the elevation rod, and
a limiter on which the hook part is hooked to restrict an elevation range of the elevation rod is disposed on the guide part.

6. The action robot according to claim 1, wherein the driving source is disposed below the second body.

7. The action robot according to claim 1, further comprising:
a sub base coupled to the second body; and
a base module in which the driving source is built, the base module being disposed below the sub base to support the sub base.

8. The action robot according to claim 7, wherein a first magnet is disposed on one of the sub base and the base module, and
a second magnet or magnetic body which is attracted to the first magnet is disposed on the other of the sub base and the base module.

9. The action robot according to claim 1, wherein the wire has one end connected to the rotation link and the other end connected to the movable part, and
a wire through-hole through which the wire passes is defined in the first body.

10. The action robot according to claim 9, wherein the wire is lengthily disposed in a direction in which the wire decreases in height from the one end to the other end.
